(19) United States
(12) Patent Application Publication
(10) Pub. No.: US 2012/0254728 A1
(43) Pub. Date: Oct. 4, 2012

(54) CONTENT ACQUIRING METHOD AND CLIENT TERMINAL

(76) Inventors: Zhifeng LIU, Nanjing (CN); Zhenhua Zhu, Nanjing (CN)

(21) Appl. No.: 13/430,829

(22) Filed: Mar. 27, 2012

(30) Foreign Application Priority Data
Mar. 28, 2011 (CN) 201110075142.0

(51) Int. Cl. G06F 17/00; G06F 15/16

(52) U.S. Cl. 715/234

(57) ABSTRACT

The invention provides a content acquiring method and a client terminal, the content acquiring method comprises acquiring, by a client terminal according to an acquired content identification, an HTML file corresponding to the content identification by using HTTP; acquiring, by the client terminal, at least two external linked identifications associated with the HTML file; and acquiring, by the client terminal according to the at least two external linked identifications, external linked resources corresponding to the at least two external linked identifications by using HTTP via one request. According to the embodiments of the present invention, it is possible to shorten the time for displaying content at the client terminal, and to reduce signaling processing load of the service server and power consumption of the client terminal.

### CROSS-REFERENCE TO RELATED APPLICATION

This application claims priority to Chinese Patent Application No. 201110075142.0, filed on Mar. 28, 2011, which is hereby incorporated by reference in its entirety.

### FIELD OF THE INVENTION

Embodiments of the present invention relate to communication technology, and particularly to a content acquiring method and a client terminal.

### BACKGROUND OF THE INVENTION

A client terminal at a terminal may request a service server to acquire content by using hypertext transfer protocol (HTTP) after it has established a connection with the service server. Specifically, after the client terminal has established the connection with the service server, it first acquires a hypertext mark-up language (HTML) file from the service server, and then the client terminal and the service server release the connection proactively; subsequently, according to the HTML file, the client terminal parses out corresponding external linked identifications such as cascading style sheets (CSS) files, JavaScript (JS) files and image files; thereafter the client terminal reestablishes connection with the service server to request the service server to acquire external linked resources corresponding to each of the external linked identifications, respectively.

However, the client terminal needs to reestablish connection with the service server after it parses out each external linked identification, and then the client terminal requests the service server to acquire the external linked resource corresponding to the external linked identification. Since the HTML file contains a great number of external linked identifications, this might lead to frequent signaling interactions between the client terminal and the service server to acquire external linked resources corresponding to the external linked identifications one by one (including establishing connection between the client terminal and the service server), prolonging the time for displaying content at the client terminal and increasing the signaling processing load of the service server and power consumption of the client terminal.

### SUMMARY OF THE INVENTION

Embodiments of the present invention provide a content acquiring method and a client terminal to shorten the time for displaying content at the client terminal, and to reduce signaling processing load of the service server and power consumption of the client terminal.

Embodiments of the present invention provide a content acquiring method, which comprises:

acquiring, by a client terminal according to an acquired content identification, an HTML file corresponding to the content identification by using HTTP;
acquiring, by the client terminal, at least two external linked identifications associated with the HTML file; and
acquiring, by the client terminal according to the at least two external linked identifications, external linked resources corresponding to the at least two external linked identifications by using HTTP via one request.

Embodiments of the present invention further provide a client terminal, which comprises:

a file acquiring module, configured to acquire, according to an acquired content identification, an HTML file corresponding to the content identification by using HTTP;
an identification acquiring module, configured to acquire at least two external linked identifications associated with the HTML file; and
a resource acquiring module, configured to acquire, according to the at least two external linked identifications, external linked resources corresponding to the at least two external linked identifications by using HTTP via one request.

As can be known from the above technical solutions, in the embodiments of the present invention, the client terminal acquires the HTML file corresponding to an acquired content identification by using HTTP and according to the content identification, and subsequently acquires at least two external linked identifications associated with the HTML file, so that according to the at least two external linked identifications, the client terminal can acquire external linked resources corresponding to the at least two external linked identifications by using HTTP via one request. Therefore it is possible to avoid the prior art problem of frequent signaling interactions between the client terminal and the service server to acquire external linked resources corresponding to the external linked identifications one by one, so as to shorten the time for displaying content at the client terminal, and to reduce signaling processing load of the service server and power consumption of the client terminal.

### BRIEF DESCRIPTION OF THE DRAWINGS

To make clearer the explanation of technical solutions of the embodiments of the present invention or of the prior art, accompanying drawings needed in the description of the embodiments or the prior art are briefly illustrated below. Apparently, the accompanying drawings illustrated below are directed to some embodiments of the present invention, and it is possible for persons ordinarily skilled in the art to deduce other drawings from these drawings without creative effort.

FIG. 1 is a schematic diagram illustrating the flow of the content acquiring method provided by Embodiment 1 of the present invention;

FIG. 2 is a schematic diagram illustrating the flow of the content acquiring method provided by Embodiment 2 of the present invention;

FIG. 3 is a schematic diagram illustrating the flow of the content acquiring method provided by Embodiment 3 of the present invention; and

FIG. 4 is a schematic diagram illustrating the structure of the client terminal provided by Embodiment 4 of the present invention.

### DETAILED DESCRIPTION OF THE PREFERRED EMBODIMENTS

To make clearer the objectives, technical solutions and advantages of the embodiments of the present invention, the technical solutions according to the embodiments of the present invention are clearly and completely described below with reference to the accompanying drawings. Apparently, the embodiments as described below are merely partial, rather than entire, embodiments of the present invention. On the basis of the embodiments of the present invention, all other embodiments obtainable by persons skilled in the art without creative effort shall all fall within the protection scope of the present invention.

As should be explained, the terminal involved in the embodiments of the present invention includes, but is not limited to, mobile phones, personal digital assistants (PDA), wireless handheld devices, wireless netbooks, personal computers, portable computers, MP3 players, MP4 players, and so on.

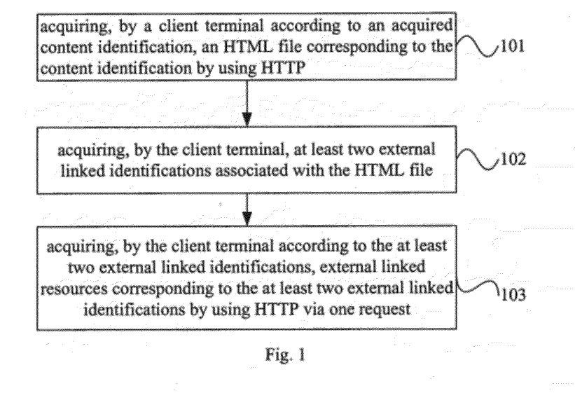

FIG. 1 is a schematic diagram illustrating the flow of the content acquiring method provided by Embodiment 1 of the present invention. As shown in FIG. 1, the content acquiring method according to the embodiment may comprise the following steps.

Step 101: acquiring, by a client terminal according to an acquired content identification, an HTML file corresponding to the content identification using HTTP;

Prior to this step, the client terminal may acquire the content identification input by a user via an input device. The content identification may be, but not limited to, a uniform resource locator (URL), such as http://www.sohu.com, or may as well be an IP address, such as http://61.135.132.12.

Step 102: acquiring, by the client terminal, at least two external linked identifications associated with the HTML file;

Step 103: acquiring, by the client terminal according to the at least two external linked identifications, external linked resources corresponding to the at least two external linked identifications using HTTP via one request.

Optionally, in Step 101 the client terminal may specifically acquire, according to the acquired content identification, the HTML file corresponding to the content identification from a service server using HTTP. Correspondingly, in Step 102 the client terminal may parse the acquired HTML file to acquire the at least two external linked identifications associated with the HTML file. Correspondingly, in Step 103 the client terminal may acquire, according to the acquired at least two external linked identifications, external linked resources corresponding to the at least two external linked identifications from the service server using HTTP via one request. Specifically, the client terminal may send an HTTP acquiring request message which includes the at least two external linked identifications to the service server, and the client terminal receives the external linked resources which are correspond to the at least two external linked identifications and returned by the service server. The client terminal in this embodiment may construct the acquired at least two external linked identifications into packets of such format as a multipart format or a multi-purpose internet mail extensions (MIME) format, so as to be carried in an HTTP acquiring request message for transmission to the service server.

Optionally, in Step 101 the client terminal may further acquire, according to the acquired content identification, the HTML file corresponding to the content identification from a proxy server using HTTP. Correspondingly, this embodiment may further comprise: acquiring, by the proxy server according to the content identification, the HTML file corresponding to the content identification from the service server using HTTP, and locally caching the HTML file. Correspondingly, in Step 102 the client terminal may further acquire the at least two external linked identifications from a link tag of the HTML file, wherein the at least two external linked identifications are acquired by the proxy server parsing the acquired HTML file. Correspondingly, this embodiment may further comprise: acquiring, by the proxy server according to the at least two external linked identifications acquired by parsing the acquired HTML file, external linked resources corresponding to the at least two external linked identifications from the service server using HTTP via one or plural requests (at least one request); then in Step 103 the client terminal may further acquire, according to the at least two external linked identifications, external linked resources corresponding to the at least two external linked identifications from the proxy server using HTTP. Specifically, the client terminal sends to the proxy server an HTTP acquiring request message which includes the at least two external linked identifications, and the client terminal receives the external linked resources which are corresponding to the at least two external linked identifications and returned by the proxy server.

The client terminal in this embodiment may construct the acquired at least two external linked identifications into packets of such format as a multipart format or an MIME format, so as to be carried in an HTTP acquiring request message for transmission to the proxy server. Correspondingly, the service server or proxy server in this embodiment may also construct the acquired external linked resources into packets of such formats as a multipart format or an MIME format, so as to be carried in an HTTP response message for transmission to the client terminal.

It should be noted that the proxy server may immediately parse the HTML file after acquiring the HTML file, acquire external linked resources corresponding to the parsed at least two external linked identifications from the service server using HTTP via at least one request, and locally store the external linked resources. Alternatively, the proxy server may also acquire external linked resources corresponding to the at least two external linked identifications from the service server using HTTP via at least one request only after receiving the HTTP acquiring request message which includes the at least two external linked identifications as sent from the client terminal, and may further locally store the external linked resources. These are not restricted in the embodiments of the present invention.

In this embodiment, according to the acquired content identification, the client terminal acquires the HTML file corresponding to the content identification from a service server by using HTTP, and subsequently acquires at least two external linked identifications associated with the HTML file, so that the client terminal can acquire external linked resources corresponding to the at least two external linked identifications by using HTTP via one request according to the at least two external linked identifications. Therefore it is possible to avoid frequent signaling interactions between the client terminal and the service server to acquire external linked resources corresponding to the external linked identifications one by one, so as to shorten the time for displaying content at the client terminal, and to reduce signaling processing load of the service server and power consumption of the client terminal.

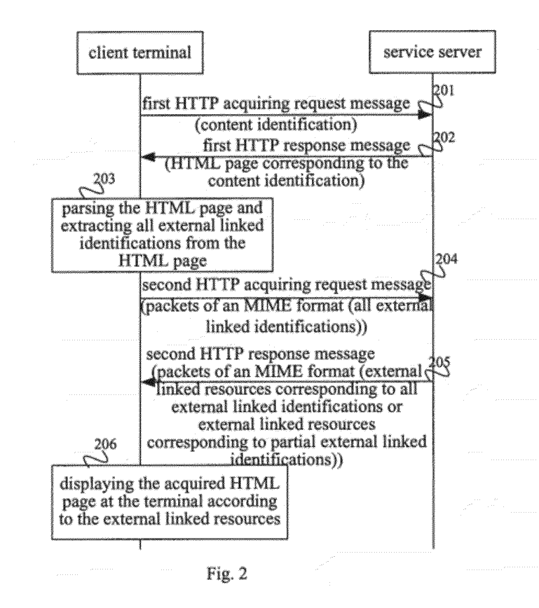

FIG. 2 is a schematic diagram illustrating the flow of the content acquiring method provided by Embodiment 2 of the present invention. As shown in FIG. 2, the content acquiring method according to this embodiment may comprise the following steps:

Step 201: sending, by the client terminal, a first HTTP acquiring request message to the service server, wherein the first HTTP acquiring request message includes an acquired content identification;

Step 202: returning, by the service server, a first HTTP response message to the client terminal, wherein the first HTTP response message includes an HTML page corresponding to the content identification;

Step 203: parsing, by the client terminal, the HTML page and extracting all external linked identifications from the HTML page;

Step 204: constructing, by the client terminal, all external linked identifications into packets of an MIME format, and sending to the service server via a second HTTP acquiring request message;

Step 205: constructing, by the service server, external linked resources corresponding to all external linked identifications or external linked resources corresponding to partial external linked identifications into packets of an MIME format, and sending to the client terminal via a second HTTP response message;

Specifically, since the size of the packets transmitted via HTTP is restricted, according to such restriction, the service server may construct external linked resources corresponding to all external linked identifications or external linked resources corresponding to partial external linked identifications into packets of an MIME format.

Step 206: after the client terminal acquires the external linked resources corresponding to all external linked identifications, displaying the acquired HTML page at the terminal according to the external linked resources.

In this embodiment, the client terminal, according to an acquired content identification, acquires the HTML page corresponding to the acquired content identification from a service server by using HTTP, and subsequently acquires at least two external linked identifications associated with the HTML page, so that the client terminal can acquire external linked resources corresponding to the at least two external linked identifications by using HTTP via one request according to the at least two external linked identifications, therefore it is possible to avoid the prior art problem of frequent signaling interactions between the client terminal and the service server to acquire external linked resources corresponding to the external linked identifications one by one, so as to shorten the time for displaying content at the client terminal, and to reduce signaling processing load of the service server and power consumption of the client terminal.

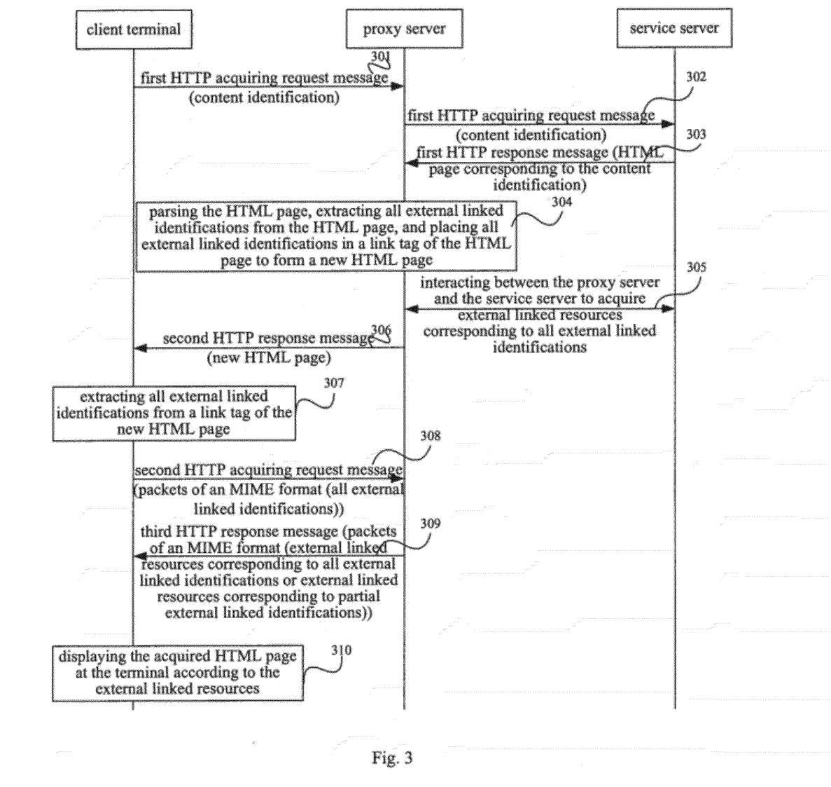

FIG. 3 is a schematic diagram illustrating the flow of the content acquiring method provided by Embodiment 3 of the present invention. As shown in FIG. 3, the content acquiring method according to the embodiment may comprise the following steps:

Step 301: sending, by the client terminal, a first HTTP acquiring request message to the proxy server, wherein the first HTTP acquiring request message includes an acquired content identification;

Step 302: sending, by the proxy server, the first HTTP acquiring request message to a service server;

Step 303: returning, by the service server, a first HTTP response message to the proxy server, wherein the first HTTP response message includes an HTML page corresponding to the content identification;

Step 304: parsing, by the proxy server, the HTML page, extracting all external linked identifications from the HTML page, and placing all external linked identifications in a link tag of the HTML page to form a new HTML page;

Step 305: the proxy server interacting with the service server to acquire external linked resources corresponding to all external linked identifications;

Specifically, the proxy server may interact with the service server for several times to respectively acquire the external linked resource corresponding to each external linked identification; alternatively, the proxy server may interact with the service server for once to acquire external linked resources corresponding to all external linked identifications.

Step 306: returning, by the proxy server, a second HTTP response message to the client terminal, wherein the second HTTP response message includes the new HTML page;

Step 307: extracting, by the client terminal, all external linked identifications from a link tag of the new HTML page;

Step 308: constructing, by the client terminal, all external linked identifications into packets of an MIME format, and sending the packets to the proxy server via a second HTTP acquiring request message;

Step 309: constructing, by the proxy server, external linked resources corresponding to all external linked identifications or external linked resources corresponding to partial external linked identifications into packets of an MIME format, and sending to the client terminal via a third HTTP response message;

Specifically, since the size of the packet transmitted via HTTP is restricted, according to such restriction, the service server may construct external linked resources corresponding to all external linked identifications or external linked resources corresponding to partial external linked identifications into packets of an MIME format.

Step 310: after the client terminal acquires the external linked resources corresponding to all external linked identifications, displaying the acquired HTML page at the terminal according to the external linked resources.

It should be noted that Step 305 can be executed either before or after Steps 306-308.

In this embodiment, after acquiring external linked resources each time, the proxy server may cache the resources to facilitate direct transmission to the client terminal upon subsequent request from the client terminal.

In this embodiment, the client terminal, according to the acquired content identification, acquires the HTML page corresponding to the acquired content identification from a service server via a proxy server by using HTTP, and subsequently acquires at least two external linked identifications associated with the HTML page from the link tag of the HTML page, so that according to the at least two external linked identifications, the client terminal can acquire external linked resources corresponding to the at least two external linked identifications from the proxy server by using HTTP via one request, therefore it is possible to avoid the prior art problem of frequent signaling interactions between the client terminal and the service server to acquire external linked resources corresponding to the external linked identifications one by one, so as to shorten the time for displaying content at the client terminal, and to reduce signaling processing load of the service server and power consumption of the client terminal.

It should be noted that, the foregoing method embodiments are described in terms of combinations of a series of actions for the sake of brevity, but it should be aware to persons skilled in the art that the present invention is not limited by the sequence of the described actions, because certain steps can be executed simultaneously or in other sequences according to the present invention. Moreover, as should also be aware to persons skilled in the art, embodiments as described in the Description are merely preferred embodiments, and the actions and modules involved therein are not necessarily indispensable to the present invention.

As different emphases are stressed in describing each of the foregoing embodiments, reference for sections not described in detail in a certain embodiment can be made to the relevant descriptions of other embodiments.

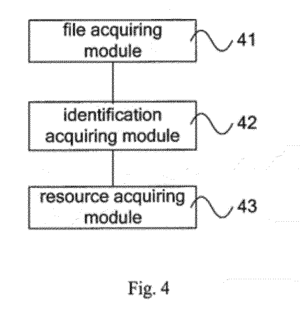

FIG. 4 is a schematic diagram illustrating the structure of the client terminal provided by Embodiment 4 of the present invention. As shown in FIG. 4, the client terminal according to this embodiment may include a file acquiring module 41, an identification acquiring module 42 and a resource acquiring module 43. The file acquiring module 41 is configured to acquire, according to an acquired content identification, an HTML file corresponding to the content identification by using HTTP. The identification acquiring module 42 is configured to acquire at least two external linked identifications associated with the HTML file. And the resource acquiring module 43 is configured to acquire, according to the at least two external linked identifications, external linked resources corresponding to the at least two external linked identifications by using HTTP via one request.

Functions of the client terminal in Embodiments 1, 2 and 3 of the present invention can all be realized by the client terminal provided by the embodiment of the present invention.

Optionally, the file acquiring module 41 according to the embodiment may be specifically configured to acquire, according to an acquired content identification, an HTML file corresponding to the content identification from a service server or a proxy server by using HTTP. Optionally, the identification acquiring module 42 may specifically be configured to parse the HTML file, and acquire the at least two external linked identifications associated with the HTML file. Optionally, the identification acquiring module 42 may specifically be configured to acquire at least two external linked identifications from a link tag of the HTML file, wherein the at least two external linked identifications are acquired by the proxy server parsing the acquired HTML file.

Correspondingly, the resource acquiring module 43 may specifically be configured to acquire, according to the at least two external linked identifications, external linked resources corresponding to the at least two external linked identifications from a service server or a proxy server by using HTTP via one request. Optionally, the resource acquiring module 43 may specifically be configured to send an HTTP acquiring request message that includes the at least two external linked identifications to the service server, and receive external linked resources that are corresponding to the at least two external linked identifications and returned by the service server. Optionally, the resource acquiring module 43 may also specifically be configured to send an HTTP acquiring request message that includes the at least two external linked identifications to the proxy server, and receive external linked resources that are corresponding to the at least two external linked identifications and returned by the proxy server. The external linked resources are acquired by the proxy server from the service server using HTTP via at least one request after the proxy server acquires the at least two external linked identifications by parsing the HTML file or after the proxy server receives the HTTP acquiring request message.

In this embodiment, the file acquiring module, according to the acquired content identification, acquires the HTML file corresponding to the acquired content identification from a service server by using HTTP and subsequently the identification acquiring module acquires at least two external linked identifications associated with the HTML file, so that the resource acquiring module can, according to the at least two external linked identifications, acquire external linked resources corresponding to the at least two external linked identifications by using HTTP via one request. Therefore it is possible to avoid the prior art problem of frequent signaling interactions between the client terminal and the service server to acquire external linked resources corresponding to the external linked identifications one by one, so as to shorten the time for displaying content at the client terminal, and to reduce signaling processing load of the service server and power consumption of the client terminal.

As comprehensible to persons ordinarily skilled in the art, the entire or partial steps of the aforementioned method embodiments can be executed by a program instruction relevant hardware, and the program can be stored in a computer-readable storage medium and, when executed, execute the steps of the aforementioned method embodiments. The storage medium can be any such media capable of storing program codes as a read-only memory (ROM), a random access memory (RAM), a magnetic disk, or an optical disk, etc.

As should be finally explained, the aforementioned embodiments are used merely to describe the technical solutions of the present invention, rather than to restrict the present invention. Although the present invention is described in detail with reference to the foregoing embodiments, it should be understood to persons ordinarily skilled in the art that the technical solutions recorded in the various foregoing embodiments can be modified or equivalently replaced with partial technical features, while such modifications or replacements would not make the corresponding technical solutions to essentially depart from the principles and scopes of the technical solutions of the various embodiments of the present invention.

What is claimed is:

1. A content acquiring method, comprising:
acquiring, by a client terminal according to an acquired content identification, a hypertext mark-up language (HTML) file corresponding to the content identification by using hypertext transfer protocol (HTTP);
acquiring, by the client terminal, at least two external linked identifications associated with the HTML file; and
acquiring, by the client terminal according to the at least two external linked identifications, external linked resources corresponding to the at least two external linked identifications by using HTTP via one request.

2. The method according to claim 1, wherein the step of acquiring, by a client terminal according to an acquired content identification, an HTML file corresponding to the content identification using HTTP comprises:
acquiring, by the client terminal according to the acquired content identification, the HTML file corresponding to the content identification from a service server or a proxy server by using HTTP.

3. The method according to claim 2, further comprising:
acquiring, by the proxy server according to the content identification, the HTML file corresponding to the content identification from the service server by using HTTP.

4. The method according to claim 2, wherein the step of acquiring, by the client terminal, at least two external linked identifications associated with the HTML file comprises:
parsing, by the client terminal, the HTML file to acquire the at least two external linked identifications associated with the HTML file.

5. The method according to claim 2, wherein the HTML file includes a link tag that includes the at least two external linked identifications, wherein the at least two external linked identifications are acquired by the proxy server parsing the acquired HTML file; wherein the step of acquiring, by the client terminal, at least two external linked identifications associated with the HTML file comprises:
acquiring, by the client terminal, the at least two external linked identifications from the link tag of the HTML file.

6. The method according to claim 1, wherein the step of acquiring, by the client terminal according to the at least two external linked identifications, external linked resources corresponding to the at least two external linked identifications by using HTTP via one request comprises:
acquiring, by the client terminal according to the at least two external linked identifications, external linked resources corresponding to the at least two external linked identifications from a service server or a proxy server by using HTTP via one request.

7. The method according to claim 6, wherein the step of acquiring, by the client terminal according to the at least two external linked identifications, external linked resources corresponding to the at least two external linked identifications from a service server by using HTTP via one request comprises:
sending, by the client terminal, an HTTP acquiring request message to the service server, wherein the HTTP acquiring request message includes the at least two external linked identifications; and
receiving, by the client terminal, external linked resources returned by the service server, wherein the external linked resources are corresponding to the at least two external linked identifications.

8. The method according to claim 6, wherein the step of acquiring, by the client terminal according to the at least two external linked identifications, external linked resources corresponding to the at least two external linked identifications from a proxy server by using HTTP via one request comprises:
sending, by the client terminal, an HTTP acquiring request message to the proxy server, wherein the HTTP acquiring request message includes the at least two external linked identifications; and
receiving, by the client terminal, external linked resources returned by the proxy server, wherein the external linked resources are corresponding to the at least two external linked identifications and.

9. The method according to claim 8, further comprising:
acquiring, by the proxy server, external linked resources corresponding to the at least two external linked identifications from a service server by using HTTP via at least one request after the proxy server acquires the at least two external linked identifications by parsing the HTML file or after the proxy server receives the HTTP acquiring request message.

10. A client terminal, comprising:
a file acquiring module, configured to acquire, according to an acquired content identification, a hypertext markup language (HTML) file corresponding to the content identification by using hypertext transfer protocol (HTTP);
an identification acquiring module, configured to acquire at least two external linked identifications associated with the HTML file; and
a resource acquiring module, configured to acquire, according to the at least two external linked identifications, external linked resources corresponding to the at least two external linked identifications by using HTTP via one request.

11. The client terminal according to claim 10, wherein the file acquiring module is specifically configured to
acquire, according to the acquired content identification, the HTML file corresponding to the content identification from a service server or a proxy server by using HTTP.

12. The client terminal according to claim 11, wherein the identification acquiring module is specifically configured to
parse the HTML file to acquire the at least two external linked identifications associated with the HTML file.

13. The client terminal according to claim 11, wherein the HTML file includes a link tag that includes the at least two external linked identifications, wherein the at least two external linked identifications are acquired by the proxy server parsing the acquired HTML file; wherein the identification acquiring module is specifically configured to
acquire the at least two external linked identifications from the link tag of the HTML file.

14. The client terminal according to claim 10, wherein the resource acquiring module is specifically configured to
acquire, according to the at least two external linked identifications, external linked resources corresponding to the at least two external linked identifications from a service server or a proxy server by using HTTP via one request.

15. The client terminal according to claim 14, wherein the resource acquiring module is specifically configured to
send an HTTP acquiring request message to the service server, wherein the HTTP acquiring request message includes the at least two external linked identifications; and receiving external linked resources returned by the service server, wherein the external linked resources are corresponding to the at least two external linked identifications.

16. The client terminal according to claim 15, wherein the resource acquiring module is specifically configured to
send an HTTP acquiring request message to the proxy server, wherein the HTTP acquiring request message includes the at least two external linked identifications; and receiving external linked resources returned by the proxy server, wherein the external linked resources are corresponding to the at least two external linked identifications,
wherein the external linked resources are acquired by the proxy server from the service server by using HTTP via at least one request after the proxy server acquires the at least two external linked identifications by parsing the HTML file or after the proxy server receives the HTTP acquiring request message.
